(19) United States
(12) Patent Application Publication
(10) Pub. No.: US 2015/0033768 A1
(43) Pub. Date: Feb. 5, 2015

(54) INSTALLATION AND METHOD FOR PREPARING LIQUID AND/OR GASEOUS CARBON DIOXIDE

(71) Applicants: Martin Blanke, Riemerling (DE); Werner Krammer, Landshut (DE)

(72) Inventors: Martin Blanke, Riemerling (DE); Werner Krammer, Landshut (DE)

(21) Appl. No.: 14/341,976

(22) Filed: Jul. 28, 2014

(30) Foreign Application Priority Data
Aug. 1, 2013 (DE) 102013012833.1

(51) Int. Cl. F17C 5/02; F17C 13/02; F17C 13/00

(52) U.S. Cl. CPC F17C 5/02; F17C 13/001; F17C 13/023
USPC 62/49.1

(57) ABSTRACT

An installation for preparing liquid and/or gaseous carbon dioxide is described, having a first container which is configured to store liquid carbon dioxide, wherein the first container is in fluid communication with a second container by at least a first pump, wherein said pump is configured for pumping carbon dioxide out of the first container via a first valve into the second container. A measuring apparatus is provided for measuring the mass of the second container, wherein the installation is configured such that the first valve is closed off so that no more carbon dioxide can be supplied to the second container when the mass of the second container measured by the measuring apparatus reaches or exceeds a predefined value. Methods for preparing liquid carbon dioxide are also provided for.

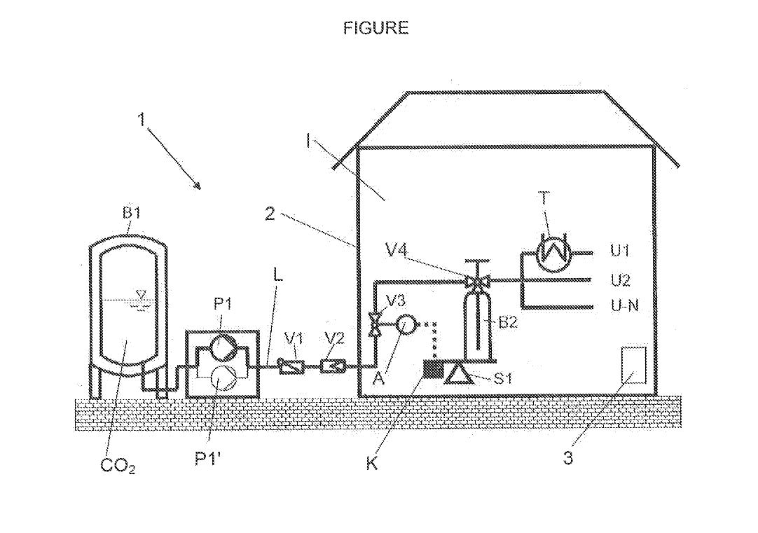

### CROSS REFERENCE TO RELATED APPLICATIONS

This application claims priority from German Patent Application DE102013012833.1 filed on Aug. 1, 2013.

### BACKGROUND OF THE INVENTION

The invention relates to an installation for preparing liquid and/or gaseous carbon dioxide and to a method for preparing liquid and/or gaseous carbon dioxide.

An installation of this type for preparing liquid or gaseous carbon dioxide generally comprises a first container for storing a stock of liquid carbon dioxide, wherein the first container is in fluid communication with a second container by means of at least a first pump and wherein that pump is configured to pump carbon dioxide out of the first container into the second container via a first valve, from which the liquid carbon dioxide can be fed for its further use. An installation of this type is known from EP 1 474 632 B1 for example.

Examples of typical applications which use or consume liquid carbon dioxide prepared using such installations are thermal spraying, physical foaming, spot cooling for gas assist injection technology or dry ice blasting.

However, the installations usually used to prepare the liquid/gaseous carbon dioxide are often complicated and expensive supply systems which are often linked with high investment costs and regularly require a lot of energy for pressure generation, cooling or heating the gas to be prepared. Alternatively, in known manner for preparing small quantities of gas, individual cylinders or small containers can be provided. However, this is often linked to high logistical outlays for the supplier.

With this background, the present invention thus aims to provide an installation and a method, in particular for the preparation of small and medium quantities of liquid or gaseous carbon dioxide (for example less than 100 kg/h and as a rule even less than 50 kg/h and in particular less than 300 kg per day) at high pressure (for example between 50 bar and 60 bar, depending on the ambient temperature), and high ambient temperatures (for example in the range 15° C. to 25° C.) which has comparatively low investment requirements as well as a comparatively small energetic and logistical outlay.

### SUMMARY OF THE INVENTION

This aim is accomplished by means of an installation for preparing liquid and/or gaseous carbon dioxide, having a first container which is configured to store liquid carbon dioxide, wherein the first container is in fluid communication with a second container by means of at least a first pump, wherein said pump is configured for pumping carbon dioxide out of the first container via a first valve into the second container, characterized in that a measuring apparatus is provided for measuring the mass of the second container, wherein the installation is configured such that the first valve is closed off so that no more carbon dioxide can be supplied to the second container when the mass of the second container measured by the measuring apparatus reaches or exceeds a predefined value.

This aim is further accomplished by a method for preparing liquid and/or gaseous carbon dioxide, in which liquid carbon dioxide stored in a first container is pumped into a second container by means of at least a first pump via a first valve,
characterized in that the mass of the second container is measured by means of a measuring apparatus, wherein the first valve is closed off, so that no more carbon dioxide can reach the second container when the mass of the second container measured by the measuring apparatus reaches or exceeds a predefined value.

Advantageous embodiments of the invention are defined in the dependent claims.

Thus, according to the invention, a measuring apparatus is provided for measuring the mass of the second container (in particular, of course, a plurality of second containers may also be provided), wherein the installation is configured such that the first valve is closed off so that no more carbon dioxide can be supplied to the second container when the mass of the second container measured by the measuring apparatus reaches or exceeds a predefined value, which in particular corresponds to complete filling of the second container, so that over-filling of the second container is prevented. Instead of the mass of the second container, the measuring apparatus can also record or calculate the mass of the carbon dioxide therein, The measuring apparatus is, for example, a balance on which the second container is disposed.

Because of this gravimetric monitoring when filling the second container from the first container, the installation of the invention advantageously does not require any return of liquid or gaseous phase of the carbon dioxide to be prepared.

In a preferred embodiment of the invention, the installation does not comprise a return of a liquid and/or gaseous phase of the carbon dioxide removed from the first container to the first container, i.e. it is open-loop, meaning that the first container is preferably connected to the second container by only a single line, which allows for a simple and efficient configuration of the installation. In this regard, each individual line can include natural branches, for example when more than one pump is used (for example a second, redundant pump), which is connected in parallel to the first pump, see below) or when at the end of said line, instead of a single second container, a plurality of containers with liquid carbon dioxide is provided (for example a gas cylinder bundle).

The first container is preferably a low pressure container which stores the liquid carbon dioxide at a pressure which is typically in the range 17 bar to 22 bar. The second container is preferably a high pressure container which stores the liquid carbon dioxide at a pressure which is preferably in the range 50 bar to 60 bar. The at least one first pump or the installation of the invention is thus configured such that the pressure of the carbon dioxide is increased on pumping the carbon dioxide into the at least one second container.

Preferably, the second container is configured as a mobile container, i.e. in particular, the first container can be moved by one person using simple aids without additional driving machinery. For stationary operation, a fixed container may be used. In particular, the first container can be in the form of a gas cylinder or a gas cylinder bundle, wherein in particular the second container comprises a second valve, in particular in the form of a three-way valve, with the aid of which the second container can be closed off or can be brought into fluid communication with the first valve.

In accordance with a preferred embodiment of the present invention, the second container does not comprise any insulation, i.e. the second container—apart from its pressure-bearing jacket—does not have any additional insulation means, for example applied to the outside of the jacket, in the approximate form of an insulating coating.

Preferably, the second container is disposed in the interior of a building (for example a workshop) of the installation through which a person can pass.

A building of this type for the installation preferably has a heating unit to heat an interior of the building which in particular is configured such that the temperature of the interior is set to a predefined temperature, in particular in the range 15° C. to 25° C. In this manner, the temperature of the second container can be controlled by means of the temperature or heat in said interior of the building, so that advantageously, additional heating or cooling can be dispensed with.

In accordance with a preferred embodiment of the invention, on the other hand, the first container is disposed outside the building. Preferably, the first container is vacuum insulated for this reason. To this end, the first container can be double-walled, with the space between the two walls being evacuated.

Preferably, the first pump with which the carbon dioxide is pumped out of the first container into the second container is preferably pneumatically driven. Furthermore, the pump is preferably redundant in design, i.e, at least one second pump is present which preferably is connected in parallel to the first pump, preferably also has a pneumatic drive and in particular is provided and set up so that it is started up when the first pump is not operating (for example because of maintenance or repair) or breaks down.

Preferably, at least one user station or a plurality of user stations are in fluid communication with the second container, in particular via said second container, wherein in particular said at least one user station, which may be for one of the applications cited above, is disposed in the building (for example in said interior).

In a further advantageous embodiment of the invention, the first and/or the second pump is in fluid communication with the second container via a return valve and/or a filter, wherein the return valve is preferably provided upstream of the first valve and wherein preferably, the filter is provided upstream of the first valve and wherein in particular, the filter is disposed downstream of the return valve. The return valve and the filter prevent the pump or the pumps and the second container from interacting or entraining contamination. In particular, the filter is supposed to retain contamination from the first container and abraded material from the pump.

In accordance with a preferred embodiment of the present invention, the installation is configured such that filling of the second container using the at least one first pump is carried out by pressurized filling at pressures above the vapor pressure of the carbon dioxide which prevails in the second container at the respective ambient temperature of the second container.

Optionally, the temperature of the liquid carbon dioxide can be controlled after intermediate storage in the second container, but this is not essential.

If appropriate, downstream of the second container as well as upstream of the at least one user station, a temperature control unit can be provided to control the temperature of the carbon dioxide removed from the second container.

In this regard, for example, a small cooling unit (preferably a simple continuous cooling unit) can be connected downstream of the second container in order to provide the consumer, as appropriate, with undercooled, bubble-free carbon dioxide.

Furthermore, in other applications, a continuous heating unit can be provided at the same site in order to heat the carbon dioxide withdrawn from the second container should warm liquid carbon dioxide be required at the user station.

Further, the problem set by the invention is solved by means of a method for preparing liquid and/or gaseous carbon dioxide as claimed in claim 15. In the method of the invention, an installation in accordance with the invention is preferably employed.

In accordance with the invention, in the method of the invention, liquid carbon dioxide stored in a first container is pumped by means of at least a first pump via a first valve into a second container wherein, in accordance with the invention, the mass of the second container is measured using a measuring apparatus, wherein the first valve is shut off so that no more carbon dioxide can reach the second container when the mass of the second container measured by the measuring apparatus reaches or exceeds a predefined value which in particular corresponds to complete filling of the second container so that over-filling of the second container is prevented (see above as well).

Preferably, in the method of the invention, no liquid or gaseous phase of the carbon dioxide removed from the first container can return to the first container. This is made possible by the gravimetric fill monitoring.

The second container in the method of the invention is again preferably configured as a mobile container, in particular a gas cylinder or a gas cylinder bundle, Preferably, the second container has no insulation.

Preferably again, the second container in the method of the invention is disposed in the interior of a building through which a person can pass, wherein the building is preferably heated, in particular to a temperature in the range 15° C. to 25° C., so that the temperature of the second container or the carbon dioxide therein in the method of the invention is preferably controlled by the heat in the interior of the building and a container pressure is set in the second container, which is preferably not insulated, which corresponds to the vapor pressure of the contents of the second container. Thus, advantageously, no additional temperature control is provided.

In contrast to the second container, the first container in the method of the invention is preferably disposed outside the building, wherein preferably, the first container is vacuum insulated (see also above) and can, for example, be refilled using a tanker as required.

In the method of the invention, the first pump is preferably driven pneumatically, whereby when the first pump is not operating (for example due to maintenance or repair) or because of a breakdown, a second pump is operated, which then ensures filling of the second container from the first container.

Furthermore, in the method of the invention, the at least one user station for supplying liquid and/or gaseous carbon dioxide is preferably in fluid communication with the second container, wherein said at least one user station is preferably disposed in the building, in particular in said interior of the building.

Furthermore, in the method of the invention, the liquid carbon dioxide is preferably pumped into the second container by means of the at least one first pump or, if appropriate, by means of the second pump via a return valve and/or a filter, wherein in particular, the return valve is disposed upstream of the first valve, and wherein in particular, the filter is disposed upstream of the first valve, and wherein in particular, the filter is disposed downstream of the return valve. The return valve and the filter as used in the method of the invention ensure that the at least one first pump and the second container to be filled or which is filled do not interact or entrain impurities.

Preferably, the pressure of the liquid carbon dioxide is raised by the at least one first pump or, if appropriate, the second pump, while pumping into the second container.

Preferably, in the method of the invention, filling of the second container is carried out by means of the at least one first pump by pressurized filling at pressures above the vapor pressure of the carbon dioxide at the respective ambient temperature of the second container.

### BRIEF DESCRIPTION OF THE DRAWINGS

Further features and advantages of the present invention will become apparent from the following description of the accompanying FIGURE showing an exemplary embodiment.

The FIGURE shows a diagrammatic view of an installation in accordance with the invention, particularly for the preparation of liquid carbon dioxide.

### DETAILED DESCRIPTION OF THE INVENTION

The FIGURE shows a diagrammatic view of an installation 1 in accordance with the invention particularly for the preparation of liquid carbon dioxide in a second container B2 which is connected to a plurality of user stations U1, U2, U-N. The user stations U1, U2, U-N in particular are for applications which consume, for example, liquid carbon dioxide at high pressure (for example between 50 bar and 60 bar) or, if appropriate, also use gaseous carbon dioxide, which may as already mentioned above, be thermal spraying, physical foaming, spot cooling for gas assist injection technology or dry ice blasting, as well as other applications which require carbon dioxide.

The installation 1 of the invention comprises a first container B1 which in particular is designed as a low pressure container; in particular, the first container B1 may be a standard tank unit. The first container B1 serves to accommodate a stock of liquid carbon dioxide and has insulation, preferably vacuum insulation or foam insulation. As a rule, foam insulated tank units are cooled using chiller units. With vacuum insulation, for example, an evacuated gap may be present between two walls of the first container B1.

The first container B1 is connected to the second container B2 via a single line L, wherein downstream of the first container B1, this line L has a first and a second pump P1, P1′ with which the liquid carbon dioxide is pumped out of the first container B1 into the second container B2. The second pump P1′ is a redundant pump which is connected in parallel to the first pump P1, i.e. the second pump P1′ is operated if the first pump P1 is not operating (for example for maintenance or repair of the first pump P1), or if the first pump P1 breaks down.

Downstream of the two pumps P1, P1′ connected in parallel, this line L has a return valve V1 as well as a filter V2 which is downstream of the return valve V1, wherein the return valve V1 and the filter V2 prevent the two pumps P1, P1′ and the second container B2 from interacting. The pumps P1 and P1′ are pressure-controlled and shut down if a set value is exceeded.

A first valve V3 is provided downstream of the filter V2 and serves to block off the line L. The first valve V3 is in fluid communication with a second valve V4 provided downstream of the first valve V3, which second valve V4 serves to close off the second container B2. The second valve V4 is configured as a three-way valve to which the user stations U1, U2, U-N which are provided are also connected. The second valve V4 is therefore adjustable such that either the second container B2 can be filled with liquid carbon dioxide via the line L from the first container B1 or liquid carbon dioxide can be fed via a riser connected to the second valve V4 from the second container B2 to the user stations U1, U2, U-N. The carbon dioxide may also be removed as a gaseous phase using known combination valves or valves without a riser.

The second container B2 is configured as a mobile container. In this regard, for example, it may be a gas cylinder or a gas cylinder bundle. A container of this type as a rule has a maximum carbon dioxide content in the range 6 kg to 37.5 kg and thus can easily be positioned in the interior I of the building 2 at its appropriate location using simple aids. Gas cylinder bundles generally have a maximum content in the range 225 kg to 450 kg and thus are usually moved using lifting equipment.

Thus, the mobile container B2 is not insulated, but its temperature is controlled by means of a heating unit 3 for the building 2 provided in the interior I in particular to a temperature in the range 15° C. to 25° C. This means that there is no need for additional heating or cooling of the installation 1.

In contrast to the second container B2, the first container B1 is disposed outside the building 2. Furthermore, the two pumps P1, P1′ as well as any return valve V1 and filter V2 are disposed outside the building 2. These components are thus easy to fill or maintain and repair from outside.

The second container B2 is filled gravimetrically from the first container B1 by means of the at least one first pump P1 (or if appropriate using the second pump P1′). In this regard, the second container B2 is disposed on a measuring apparatus S1 which is configured such that the mass of the second container B2 is registered. To this end, the measuring apparatus S1 comprises a control unit K which controls an actuator A using the registered mass of the second container B2 to open or close the first valve V3. If, for example, the measuring apparatus S1 registers a mass of the second container B2 which reaches or exceeds a predefined mass which corresponds to complete filling of the second container B2 with liquid carbon dioxide, the control unit K drives the actuator A such that it closes the first valve V3 as a result of which no more liquid carbon dioxide can reach the second container B2. In this manner, over-filling of the second container B2 is prevented. This gravimetric monitoring of filling of the second container B2 advantageously allows for a return for gaseous or liquid carbon dioxide to the first container B1 to be dispensed with. In this manner, the system of the invention is simple and inexpensive to realize. The pressure set in the respective second container B2 corresponds to the vapor pressure of the carbon dioxide inside the second container B2 and thus is suitable for the applications or user stations U1, U2, U-N. The user stations U1, U2, U-N are respectively from the freshly filled stock of gas in the second container supplied B2.

Advantageously, the pumps P1 or P1′ in the installation 1 of the invention or the method of the invention respectively operate only over the comparatively short time required to fill the second container B2. Although the respective applications U1, U2, U-N require liquid carbon dioxide, no energy is required to supply the gas. Furthermore, the installation 1 of the invention does not require a chiller for the tank unit or the first container B1 or the second container B2. The second container B2 is filled only as a pressurized filling at pressures above the vapor pressure of the carbon dioxide at the ambient temperature in the interior I of the building 2. As an example, at 20° C., carbon dioxide has a vapor pressure of 57 bar. Filling in this case is preferably carried out at 70 bar to 80 bar, preferably 75 bar. The second containers B2 (for example gas cylinders or gas cylinder bundles) preferably contain a stock which allows the user to work for a longer period without having to refill using the pump P1 or P1′. Temperature control of the liquid carbon dioxide after intermediate storage in the second container B2 is optionally possible but not essential.

In isolated cases, for example, a small cooling unit (preferably a single continuous cooling unit) can be connected downstream of the filled container B2 in order, if appropriate, to prepare undercooled bubble-free carbon dioxide. At the same time, a continuous heating unit could be envisaged for other applications.

What we claim is:

1. An installation for preparing liquid and/or gaseous carbon dioxide, comprising:
a first container which is configured to store liquid carbon dioxide, wherein the first container is in fluid communication with a second container by means of at least a first pump, wherein said first pump is configured for pumping carbon dioxide out of the first container via a first valve into the second container,
characterized in that
a measuring apparatus is provided for measuring the mass of the second container, wherein the installation is configured such that the first valve is closed off so that no more carbon dioxide can be supplied to the second container when the mass of the second container measured by the measuring apparatus reaches or exceeds a predefined value.

2. The installation as claimed in claim 1, characterized in that the installation does not include a return to the first container of a liquid and/or gaseous phase of the carbon dioxide removed from the first container.

3. The installation as claimed in claim 1, characterized in that the second container is configured as a mobile container.

4. The installation as claimed in claim 3, characterized in that the mobile container is a gas cylinder or gas cylinder bundle.

5. The installation as claimed in claim 3, characterized in that the second container comprises a second valve.

6. The installation as claimed in claim 5, characterized in that the second valve is a three-way valve.

7. The installation as claimed in claim 6, characterized in that the second container is in fluid communication with the first valve.

8. The installation as claimed in claim 1, characterized in that the second container has no heat insulation.

9. The installation as claimed in claim 1, characterized in that the second container is disposed in an interior of a building of the installation through which a person can pass.

10. The installation as claimed in claim 9, characterized in that the building is provided with a heating unit to heat the interior of the building.

11. The installation as claimed in claim 10, characterized in that the heating unit heats the interior to a predefined temperature.

12. The installation as claimed in claim 11, characterized in that the predefined temperature is in the range of 15° C. to 25° C.

13. The installation as claimed in claim 5, characterized in that the first container is disposed outside the building.

14. The installation as claimed in claim 1, characterized in that the first container is insulated.

15. The installation as claimed in claim 14, characterized in that the first container is insulated with a vacuum insulation and/or a foam insulation.

16. The installation as claimed in claim 1, characterized in that the first pump is configured so as to be pneumatically driven.

17. The installation as claimed in claim 1, characterized in that the first container is in fluid communication with the second container via a further second pump.

18. The installation as claimed in claim 17, characterized in that the second pump is configured so as to be pneumatically driven.

19. The installation as claimed in claim 17, characterized in that the second pump is configured as a redundant pump which is provided and set up to be operated if the first pump is not operating or breaks down.

20. The installation as claimed in claim 1, characterized in that at least one user station is in fluid communication with the second container.

21. The installation as claimed in claim 20, characterized in that the at least one user station is in fluid communication with the second container via the second valve.

22. The installation as claimed in claim 21, characterized in that the at least one user station is disposed in the building.

23. The installation as claimed in claim 1, characterized in that the first and/or the second pump is in fluid communication with the second container via a return valve and/or a filter.

24. The installation as claimed in claim 23, characterized in that the return valve is provided upstream of the first valve.

25. The installation as claimed in claim 24, characterized in that the filter is provided upstream of the first valve.

26. The installation as claimed in claim 25, characterized in that the filter is disposed downstream of the return valve.

27. The installation as claimed in claim 1, characterized in that the installation is configured such that filling of the second container by means of the at least one first pump and/or the second pump is carried out as a pressurized filling at pressures above the vapor pressure of the carbon dioxide at the respective ambient temperature of the second container.

28. The installation as claimed in claim 1, characterized in that the installation comprises a temperature control unit which is provided downstream of the second container to control the temperature of the carbon dioxide removed from the second container.

29. A method for preparing liquid and/or gaseous carbon dioxide, in which liquid carbon dioxide stored in a first container is pumped into a second container by means of at least a first pump via a first valve,
characterized in that
the mass of the second container is measured by means of a measuring apparatus, wherein the first valve is closed off, so that no more carbon dioxide can reach the second container when the mass of the second container measured by the measuring apparatus reaches or exceeds a predefined value.
